(19) United States
(12) Patent Application Publication
(10) Pub. No.: US 2016/0296058 A1
(43) Pub. Date: Oct. 13, 2016

(54) TRAVEL TEA KEEPER AND INFUSER

(71) Applicant: Progressive International Corporation, Kent, WA (US)

(72) Inventor: Lawrence M. Hauser, Auburn, WA (US)

(21) Appl. No.: 15/093,058

(22) Filed: Apr. 7, 2016

Related U.S. Application Data
(60) Provisional application No. 62/145,115, filed on Apr. 9, 2015.

(51) Int. Cl. A47J 31/00; B65D 25/24; B65D 43/02; A47G 19/16; B65D 25/28

(52) U.S. Cl. CPC A47J 31/005; A47G 19/16; B65D 25/28; B65D 43/02; B65D 25/24; B65D 2525/283

(57) ABSTRACT

A device for storing tea in a portable manner suitable for travel includes a main body attached to a container, in which the main body houses a tea infuser and the container is suitable for storing tea. The infuser is removably stored within the main body and may include a handle that is moveable to a retracted position for storage.

### PRIORITY CLAIM

This application claims the benefit of U.S. provisional application 62/145,115, filed Apr. 9, 2015, the contents of which are incorporated by reference.

### BACKGROUND OF THE INVENTION

Many people enjoy drinking tea, and further find that it is an enjoyable beverage when traveling. Tea is best when brewed shortly before consuming it, and for that reason it is preferable to be able to carry tea in a dry form, separate from hot water, until it is ready to be used. When using loose tea, this also means carrying an infuser to use with the loose tea. After use, the infuser must be removed from the cup or container of hot water, and presents a storage problem when traveling. In many cases, a person must bring a plastic bag or other article to use for storing the infuser and its spent tea leaves. There is presently no suitable device for carrying a tea infuser and loose tea that also facilitates storage of the tea infuser in an acceptable way after it has been used.

### SUMMARY OF THE INVENTION

The present invention relates to a device for storing tea, preferably including loose tea, in a portable manner suitable for travel. In addition, a preferred version of the present invention incorporates a tea infuser which may be stored in a separate receptacle but within the same device that houses the stored tea.

In one version, the travel tea infuser includes a main body defining a first interior volume, a tea infuser removably stored within the first interior volume, a container attached to the main body and defining a second interior volume, the first interior volume being separated from the second interior volume by an interior wall which prevents direct fluid communication between the first interior volume and the second interior volume, and a lid removably attached to the container and enclosing the second interior volume.

In some versions, the travel tea infuser further comprises a cap removably attached to the main body, the cap removably enclosing the tea infuser within the main body.

In some examples, the cap is formed as a base for the travel tea infuser. Thus, in some versions the infuser, container, and main body are all formed to be positioned along a common central axis, with a lid removably attached above the container and a base or cap removably attached beneath the main body.

In some versions, the container is permanently attached to the main body.

In one example, the tea infuser further comprises a tea infuser body and a tea infuser lid removably attachable to the tea infuser body, the tea infuser lid further having a handle moveable between a stowed position and an extended position.

The tea infuser may further comprise a tea infuser base positioned opposite the tea infuser lid, and further wherein when the handle is in the stowed position the handle extends along a portion of the tea infuser lid and further extends to the tea infuser base.

### BRIEF DESCRIPTION OF THE DRAWINGS

Preferred and alternative examples of the present invention are described in detail below with reference to the following drawings.

FIG. 1 is a perspective view of a preferred travel tea keeper and infuser.

FIG. 2 is a front elevational view of a preferred travel tea keeper and infuser.

FIG. 3 is a sectional view of a preferred travel tea keeper and infuser, taken along lines 3-3 in FIG. 2.

FIG. 4 is an exploded view of a preferred travel tea keeper and infuser.

FIG. 5 is a perspective view of a preferred infuser, shown with a handle in a retracted position.

FIG. 6 is a perspective view of a preferred infuser, shown with a handle in an extended position.

FIG. 7 is an exploded view of a preferred infuser.

FIG. 8 is a perspective view of a preferred infuser, shown positioned in a mug.

### DETAILED DESCRIPTION OF THE PREFERRED EMBODIMENT

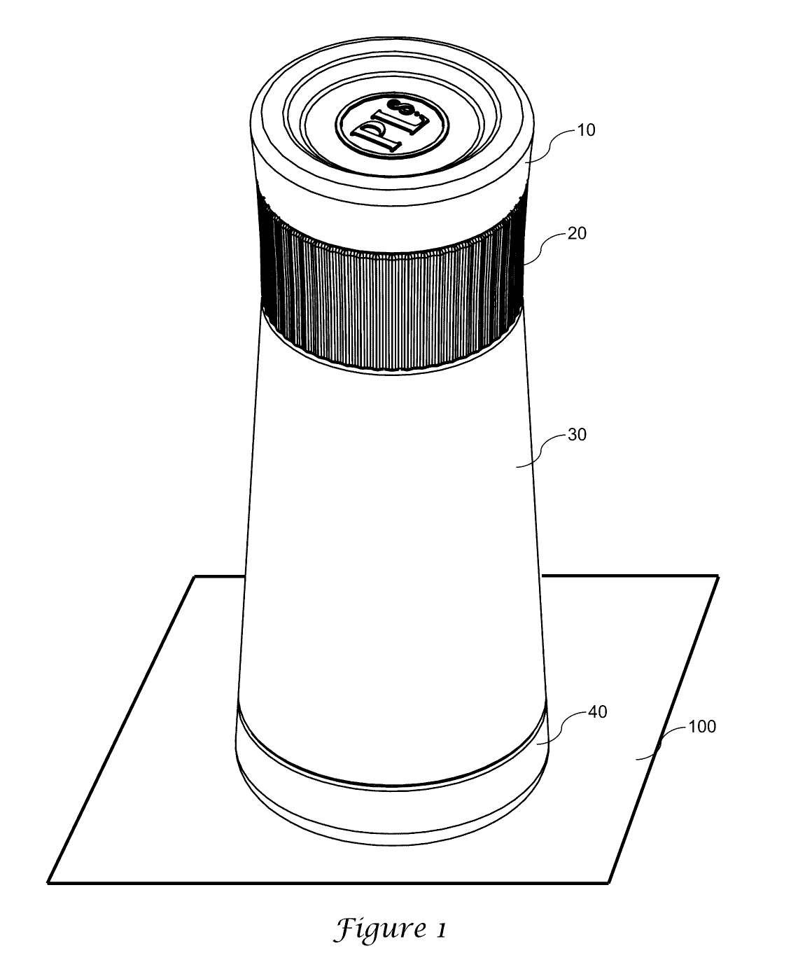

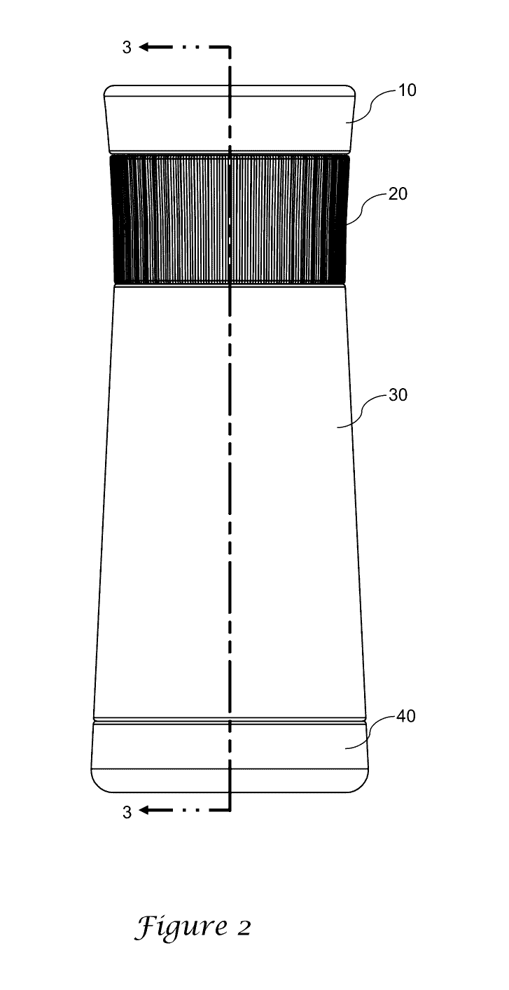

A preferred portable tea keeper and infuser is illustrated in FIGS. 1 and 2, and includes a container 20 configured to receive and retain loose tea. The tea container as illustrated is configured with an outer sidewall forming a short substantially upright cylinder, though in other versions the container may have a different shape.

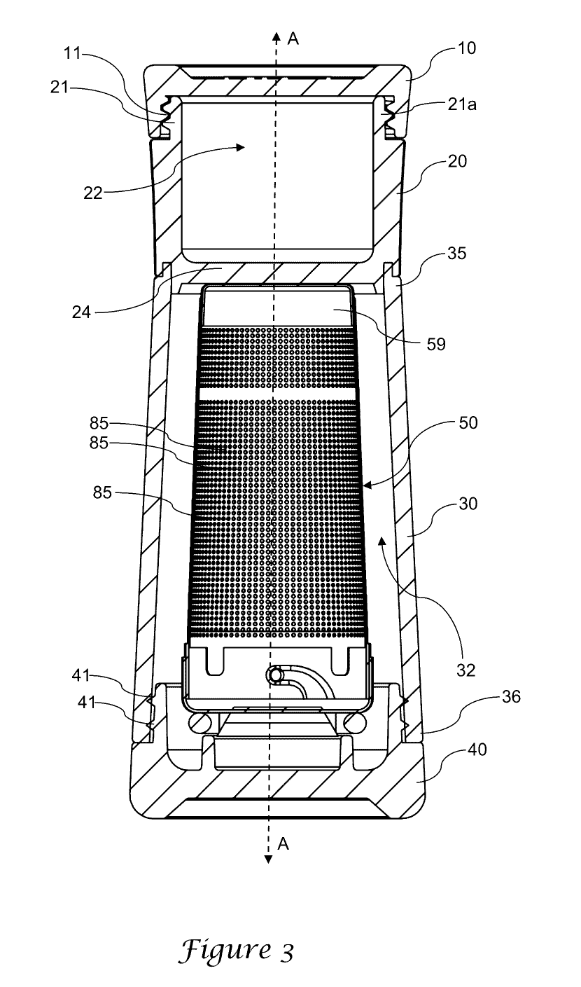

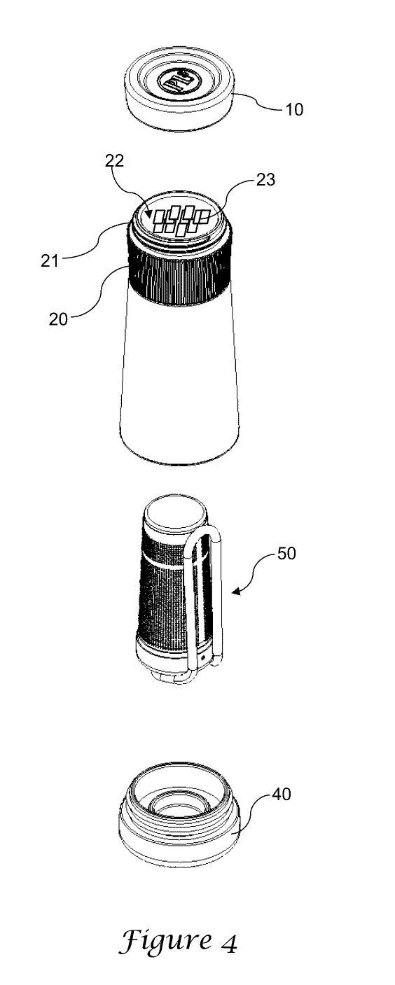

As best seen in the sectional view of FIG. 3, the container defines an interior volume 22. As shown in the exploded view of FIG. 4, the interior volume is capable of storing loose tea 23. In some examples of the invention, the interior volume is less than one cup, and more preferably about one half cup or less. The container 20 preferably includes an upper neck 21 formed with threads 21a to engage mating threads 11 formed on a lid 10 which is sized and configured to cover the container and seal the interior volume. While the lid is preferably removably attached via a threaded engagement, in other versions it may be snap-fit, friction-fit, or otherwise removably attached.

The container is secured to a main body 30, in which the main body is preferably formed to define an interior volume 32 capable of housing an infuser 50 as described further below. In the illustrated example, as best seen in FIG. 3, the main body 30 includes an upper end 35 and a lower end 36 generally defining a truncated conical shape in which the upper end has a smaller diameter than the lower end. The interior volume 32 of the main body has a similar shape, being smaller than the exterior shape by the thickness of the material forming the main body. In one example of the invention, the main body is formed from a clear plastic material. Most preferably, the upper end of the main body is permanently attached to the bottom of the container 20 by sonic welding or other means, so that the container 20 is supported atop the main body 30. In this fashion, the device will preferably include a first interior volume 32 and a second interior volume 22, each separated by an interior wall. Likewise, the first interior volume is preferably separated from the second interior volume by an interior wall 24, which provides a seal that separates the first and second interior volumes and prevents fluid or air travel between them. Although a single wall panel is illustrated for the interior wall 24, in other versions it may be double-walled or otherwise configured. For example, in one version the upper container may be threadably or otherwise removably attached to the main body, allowing access to the first interior volume by removing the container.

A cap, preferably formed as a base 40, is removably attachable to the bottom of the main body 30. As best seen in FIG. 1, in one version the base provides stable support for the device when resting on a horizontal surface 100. In the illustrated version, the base includes an upwardly extending rim having a number of radial flexible fins 41. The fins 41 are deformable to create a substantial seal when the rim of the base is inserted into the bottom of the main body, in order to enclose the main body with the base. In other versions, either or both of the lid and base may be configured with threaded, press-fit, snap-fit, or other attachment structures.

As shown in FIG. 3, in one version the travel tea infuser is configured to extend along axis A-A, in which the base 40 is at the bottom, the main body 30, extends axially upward from the base, the tea infuser 50 is co-axially and concentrically received within the first volume 32, the container 20 is axially above the main body, and the cap 10 is axially above the container. Most preferably, the axis A-A is also a common central axis for each of the cap 10, the container 20 and its volume 22, the main body 30 and its volume 32, and the base 40.

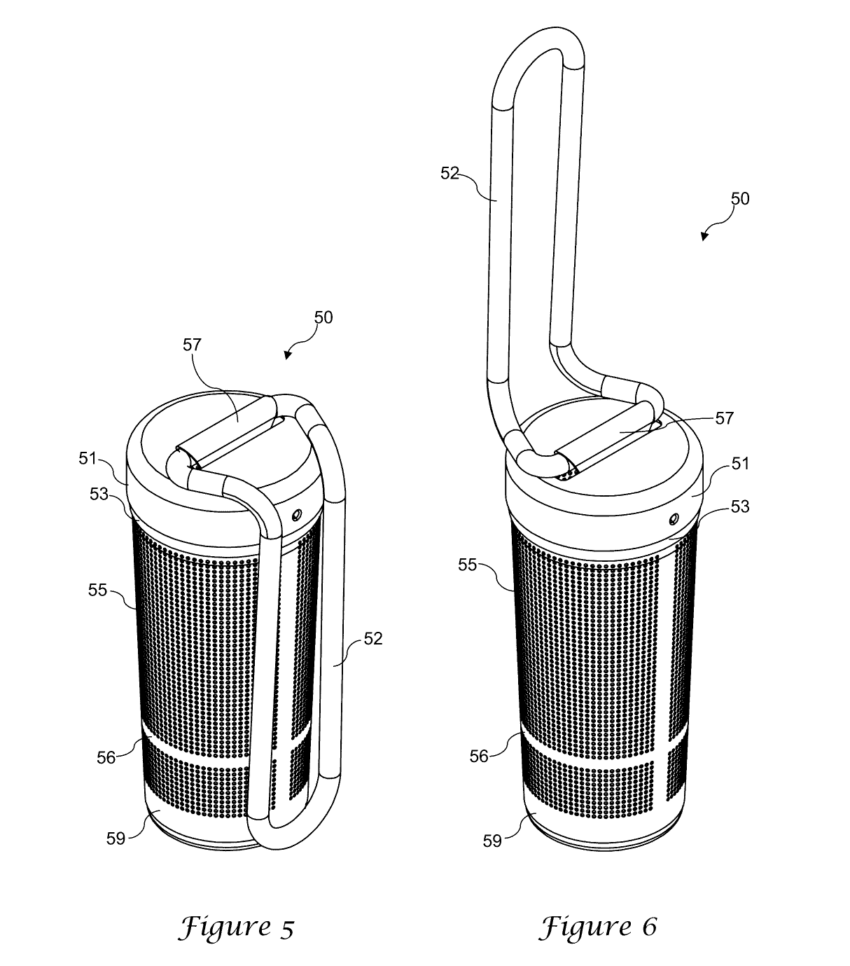

An infuser 50 is configured to fit within the main body for storage and for steeping loose tea in a cup or other container of hot water when in use. In the illustrated example, as seen in FIGS. 5-7, the preferred infuser 50 includes an infuser body 55 having an upper end attached to an infuser ring 53 and a lower end attached to an infuser base 59. The infuser body 55 is preferably formed with an inverted truncated conical shape in which the diameter of the infuser is greater at the upper end than at the lower end. The size and shape of the infuser are defined such that the infuser fits within the interior volume 32 formed by the main body 30 for storage. Because the main body is formed to be narrower at the top than at the bottom in the preferred version, the largest possible infuser fits best within the main body if it is inserted when inverted, with the infuser base 59 positioned above the infuser ring. In other versions the infuser main body may be cylindrical or have other shapes, though preferably still configured to fit within the main body for storage.

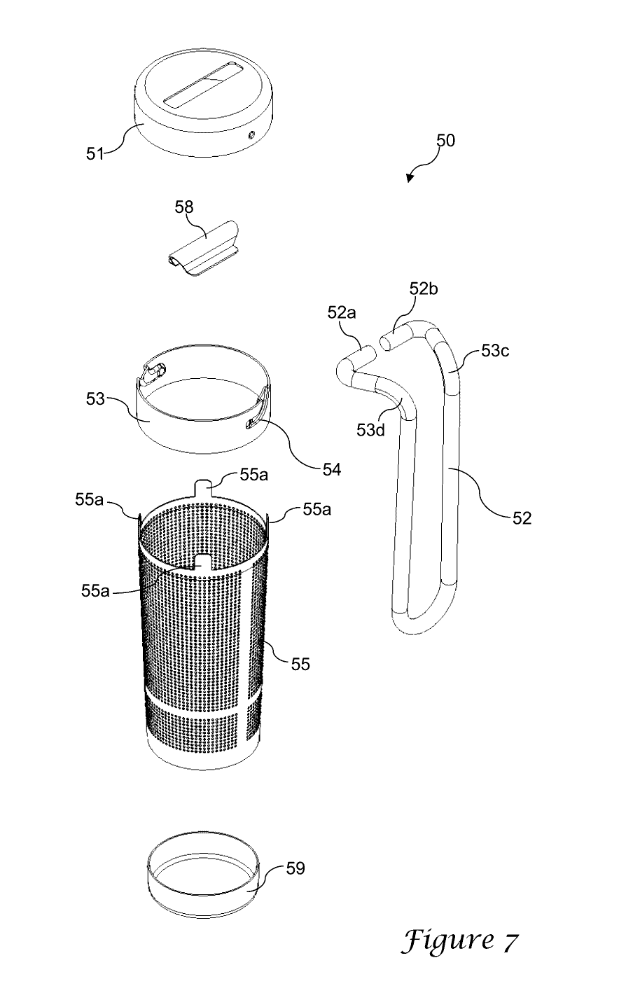

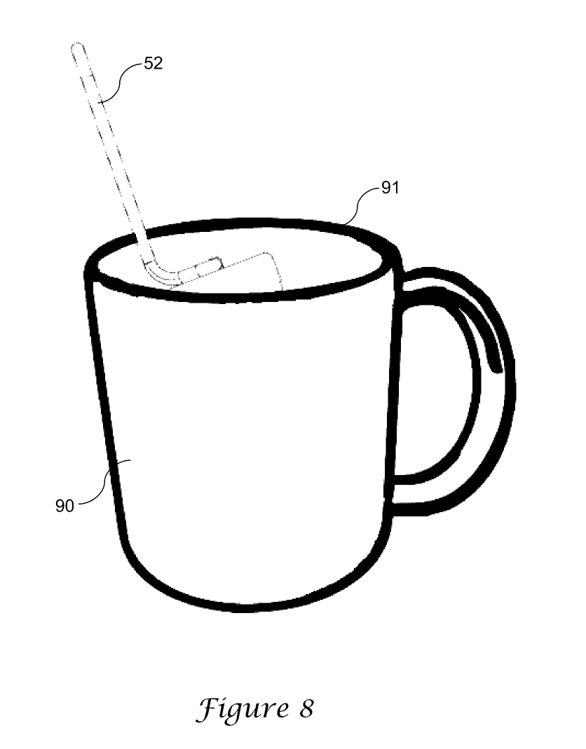

In one example, the infuser body 55 is formed from stainless steel, which is preferably 0.25 mm thick. The infuser base and ring are preferably also formed from stainless steel. The infuser body contains a number of holes 85 (see FIG. 3) to allow water to flow through the infuser body, and in one version the holes are created by etching the stainless steel body. The infuser base 59 also preferably includes a bottom portion or floor having etched through-holes as with the infuser body. The bottom portion of the infuser base transitions to an upwardly-extending sidewall which preferably does not include through holes. The infuser base is preferably welded to the lower portion of the infuser body, and the infuser ring is welded to the top portion of the infuser body, to form the infuser. In one version, as seen in FIG. 7, the upper end of the infuser body includes one or more upwardly-extending tabs 55a to facilitate the attachment of the ring to the body. Most preferably, four or five tabs are provided, spaced uniformly about the upper rim of the infuser body, so that the infuser body is spot-welded to the infuser ring only at the location of the tabs.

The infuser ring 53 is configured to attach to an infuser lid 51, and in the illustrated example the infuser ring attaches to the infuser lid via a short, steep threaded engagement or a bayonet lock 54.

The infuser lid 51 further includes a handle 52 pivotally attached to the infuser lid. In one version, the handle is formed from stainless steel wire formed with an approximately 90 degree bend 53c, 53d at the end of each upright in the U-shaped handle, each terminal end 52a, 52b then being bent inward toward the interior of the U-shape. Most preferably, the infuser lid includes a raised sleeve 58 configured to receive the inward-facing terminal ends 52a, 52b of the wire handle for pivotal attachment of the handle to the infuser lid 51.

The shape of the handle allows the handle to be pivoted to a stowed position (as illustrated in FIG. 5) in which the U-shaped portion of the handle 52 closely follows the infuser body 55, then the terminal portion of the handle after the 90 degree bend rests against the lid 52 to provide a compact shape for storage. Thus, in the stowed position the handle is positioned against the infuser body for all or substantially all of the length of the infuser body.

The handle 52 may also be pivoted upward to an extended position (as illustrated in FIG. 6) in which the handle extends generally axially away from the infuser body. In the illustrated example, the handle pivots through an angle of about 180 degrees to transition between the stowed and extended positions. The handle, infuser, and main body are preferably sized and shaped so that the infuser and handle fit within the main body for storage with the infuser lid attached to the infuser body and the handle rotated to the stowed position. Thus, in the stowed position the handle extends from the lid of the tea infuser downward toward the base of the tea infuser, and is generally aligned parallel to the central axis A-A. In the extended position the handle is rotated 180 degrees so that it extends away from the direction of the base of the tea infuser, and is also aligned generally parallel to the central axis A-A.

In use, a desired quantity of tea (preferably including loose tea) can be stored within the interior volume 22 defined by the upper container 20. The loose tea may be accessed by removing the lid 10, and stored to retain freshness by securing the lid.

The infuser 50 is stored within the internal cavity 32 formed main body 30 and beneath the upper container 20. As illustrated, the handle is rotated into the stowed position for storage, allowing the infuser and its handle to fit within the internal space. Most preferably the handle in the stowed position extends along the entire sidewall of the tea infuser. Once the infuser is in position, the base 40 can be attached to the main body to seal the infuser within the main body. Thus, the container houses loose tea in a first internal volume and houses an infuser in a second internal volume, separated from the first internal volume by the bottom of the upper container 20. Most preferably, the first and second internal volumes are divided by a barrier (as illustrated, the floor of the upper container) that prevents moisture from traveling between them.

In order to make tea with the infuser and stored tea, the base 40 is removed from the main body 30 and the infuser 50 is removed from the interior 32 of the main body. The infuser lid 51 is removed from the infuser so that tea can be placed within the infuser. In one version of the invention, the infuser body includes a band 56 that does not include etched holes, as best seen in FIGS. 5 and 6. Most preferably the band is positioned at a location to define a desired volume between the band 56 and the floor of the base 59 of the infuser. In one example, the volume between the band and the base of the infuser defines one teaspoon. In other versions of the invention, the band or volumetric indicator may be formed differently, such as by the formation of a different hole pattern in the region of the band. Tea is removed from the tea container 20 in a desired volume and placed in the infuser, then the infuser lid is returned atop the infuser. The handle 52 is preferably rotated to an extended position so that the handle will extend above the rim 91 of a cup 90 when the infuser is placed within a cup of hot water, such as illustrated in FIG. 8.

As desired by a user, the infuser may be placed in an empty cup, then hot water poured into the cup so that the tea may steep in the hot water, or it may be placed in a cup already filled with hot water. After a desire period of time steeping, the infuser can be removed from the cup, allowing the tea to drain through the holes in the infuser but removing the loose tea with the infuser. The infuser can then be cleaned and stored again within the main body in the manner described above.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

The embodiments of the invention in which an exclusive property or privilege is claimed are defined as follows:

1. A travel tea infuser, comprising:
a main body defining a first interior volume;
a tea infuser removably stored within the first interior volume;
a container attached to the main body and defining a second interior volume, the first interior volume being separated from the second interior volume by an interior wall which prevents direct fluid communication between the first interior volume and the second interior volume; and
a lid removably attached to the container and enclosing the second interior volume.

2. The travel tea infuser of claim 1, comprising a cap removably attached to the main body, the cap removably enclosing the tea infuser within the main body.

3. The travel tea infuser of claim 2, wherein the cap is formed as a base for the travel tea infuser.

4. The travel tea infuser of claim 3, wherein the container is permanently attached to the main body.

5. The travel tea infuser of claim 1, wherein the tea infuser further comprises a tea infuser body and a tea infuser lid removably attachable to the tea infuser body, the tea infuser lid further having a handle moveable between a stowed position and an extended position.

6. The travel tea infuser of claim 5, wherein the tea infuser further comprises a tea infuser base positioned opposite the tea infuser lid, and further wherein when the handle is in the stowed position the handle extends along a portion of the tea infuser lid and further extends to the tea infuser base.

7. The travel tea infuser of claim 6, further comprising a cap removably attached to the main body, the cap removably enclosing the tea infuser within the main body.

8. The travel tea infuser of claim 7, wherein the cap is formed as a base for the travel tea infuser, the lid being positioned axially opposite the base.

9. A travel tea infuser, comprising:
a main body defining a first interior volume;
a tea infuser removably stored within the first interior volume;
a removable base providing support for the main body, the removable base enclosing the first interior volume and the tea infuser within the first interior volume;
a container attached to the main body such that the first interior volume is positioned between the base and the container, the container defining a second interior volume, the first interior volume being separated from the second interior volume by an interior wall which prevents direct fluid communication between the first interior volume and the second interior volume; and
a lid removably attached to the container and enclosing the second interior volume.

10. The travel tea infuser of claim 9, wherein the container is permanently attached to the main body.

11. The travel tea infuser of claim 9, wherein the tea infuser further comprises a tea infuser body and a tea infuser lid removably attachable to the tea infuser body, the tea infuser lid further having a handle moveable between a stowed position and an extended position.

12. The travel tea infuser of claim 11, wherein the tea infuser further comprises a tea infuser base positioned opposite the tea infuser lid, and further wherein when the handle is in the stowed position the handle extends along a portion of the tea infuser lid and further extends to the tea infuser base.

13. The travel tea infuser of claim 12, wherein the handle is pivotally attached to the lid.

14. The travel tea infuser of claim 13, wherein the lid further comprises a raised sleeve, the handle being pivotally attached to the raised sleeve.

15. A travel tea infuser, comprising:
a main body defining a first interior volume;
a container attached to the main body and defining a second interior volume;
a tea infuser removably stored within the first interior volume, the main body, the container, and the tea infuser all having a common central axis when the tea infuser is stored within the first interior volume.

16. The travel tea infuser of claim 15, further comprising a cap removably attached to the main body, the cap removably enclosing the tea infuser within the main body.

17. The travel tea infuser of claim 16, wherein the cap is formed as a base for the travel tea infuser.

18. The travel tea infuser of claim 15, wherein the container is permanently attached to the main body.

19. The travel tea infuser of claim 15, wherein the tea infuser further comprises a tea infuser body and a tea infuser lid removably attachable to the tea infuser body, the tea infuser lid further having a handle moveable between a stowed position and an extended position.

20. The travel tea infuser of claim 19, wherein the tea infuser further comprises a tea infuser base positioned opposite the tea infuser lid, and further wherein when the handle is in the stowed position the handle extends along a portion of the tea infuser lid and further extends to the tea infuser base.
